(19) United States
(12) Patent Application Publication
(10) Pub. No.: US 2018/0141372 A1
(43) Pub. Date: May 24, 2018

(54) LOOP CONNECTION SYSTEM

(71) Applicants: Roberto Antonio, JR., Pacifica, CA (US); Scott Eckerman, Saratoga, CA (US)

(72) Inventors: Roberto Antonio, JR., Pacifica, CA (US); Scott Eckerman, Saratoga, CA (US)

(21) Appl. No.: 15/357,339

(22) Filed: Nov. 21, 2016

(51) Int. Cl. B44B 11/00

(52) U.S. Cl. CPC B44B 11/00

(57) ABSTRACT

A system and method for an amusement construction system offering simple, safe, and efficient features and solutions unavailable in any other amusement construction system. An anchor body supports one or more extensions, each extension may include one or more semi-flexible loops. The loops are semi-flexible in that they may be deformed to pass through another semi-flexible loop while springingly returning to the undeformed state which is rigid enough to maintain a desired level of coupling. A decoupling strength is related to how easily the semi-flexible loops deform sufficiently to pass through a loop to which it is coupled.

### FIELD OF THE INVENTION

The present invention relates generally to an amusement system, and more specifically, but not exclusively, to a construction system capable of forming a wide variety of constructed shapes that can be safe for young children.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

There are a great many differing construction systems available in the amusement marketplace reflecting their appeal to a great many consumers. A particular construction system typically offers trade-offs when compared to other construction systems. Many consumers, and the marketplace, are often interested in new construction systems to maintain a higher level of interest.

What is needed is a system and method for an amusement construction system offering simple, safe, and efficient features and solutions unavailable in any other amusement construction system.

### BRIEF SUMMARY OF THE INVENTION

Disclosed is a system and method for an amusement construction system offering simple, safe, and efficient features and solutions unavailable in any other amusement construction system.

The following summary of the invention is provided to facilitate an understanding of some of the technical features related to amusement construction system, and is not intended to be a full description of the present invention. A full appreciation of the various aspects of the invention can be gained by taking the entire specification, claims, drawings, and abstract as a whole. The present invention is applicable to other construction systems and connection methods in addition to use of a closed flexible loops.

An embodiment of the present invention may include an anchor body supporting one or more extensions, each extension may include one or more semi-flexible loops. The loops are semi-flexible in that they may be deformed to pass through another semi-flexible loop while springingly returning to the undeformed state which is rigid enough to maintain a desired level of coupling. A decoupling strength is related to how easily the semi-flexible loops deform sufficiently to pass through a loop to which it is coupled.

An embodiment of the present invention may include a hook latch tool to aid in formation and coupling for construction.

An apparatus, including an elastomeric body having a plurality of portions including a foundation portion with a first vertex and a second vertex, a first extension portion associated with said first vertex, a second extension portion associated said second vertex, a first loop structure portion coupled to said first extension portion, and a second loop structure portion coupled to said second extension portion; wherein each said loop structure portion includes one or more closed loops, each said closed loop defining a void having a set of void metrics and having a loop thickness; wherein each said extension portion has an extension distance from its associated vertex to its coupled loop structure portion defining an extension length that is at least equal to said loop thickness; and wherein each said extension portion includes a cross section perimeter having a set of extension metrics compatible with said set of void metrics allowing any particular extension to extend through said void.

A construction set, including one or more first elastomeric bodies each having a first plurality of portions including a first foundation portion defining a first set of vertices, a first set of extension portions associated with said first set of vertices with a least one extension portion at each said vertex of said first set of vertices, and a first set of loop structure portions associated with said first set of extensions with at least one loop structure portion at each said extension portion of said first set of extension portions; one or more second elastomeric bodies each having a second plurality of portions including a second foundation portion defining a second set of vertices, a second set of extension portions associated with said second set of vertices with a least one extension portion at each said vertex of said second set of vertices, and a second set of loop structure portions associated with said second set of extensions with at least one loop structure portion at each said extension portion of said second set of extension portions; wherein each said loop structure portion includes one or more closed loops, each said closed loop defining a void having a set of void metrics and having a loop thickness; wherein each said extension portion has an extension distance from its associated vertex to its coupled loop structure portion defining an extension length that is at least equal to said loop thickness; and wherein each said extension portion includes a cross section perimeter having a set of extension metrics compatible with said set of void metrics allowing any particular extension to extend through said void.

A construction method, including a) hooking, using a hook portion of a hook latch tool in an unlatched mode, a first particular one closed loop of a first elastomeric body having a plurality of portions including a foundation portion with a first vertex and a second vertex, a first extension portion associated with said first vertex, a second extension portion associated said second vertex, a first loop structure portion coupled to said first extension portion, and a second loop structure portion coupled to said second extension portion; wherein each said loop structure portion includes one or more closed loops, each said closed loop defining a void having a set of void metrics and having a loop thickness; wherein each said extension portion has an extension distance from its associated vertex to its coupled loop structure portion defining an extension length that is at least equal to said loop thickness; and wherein each said extension portion includes a cross section perimeter having a set of extension metrics compatible with said set of void metrics allowing any particular extension to extend through said void; b) transitioning, beyond a latching portion of said hook latch tool, said first particular one closed loop down a shaft portion of said hook latch tool with said shaft portion coupled to said hook portion; c) hooking, using said hook portion, a second particular one closed loop from said first elastomeric body or a second elastomeric body conforming to said first elastomeric body; d) transitioning said hook latch tool to a closed mode while said second particular one closed loop is hooked by said hook portion; e) transitioning said first particular one closed loop off said shaft portion and beyond said hook portion off of said hook latch tool which also transitions said first particular one closed loop over said second particular one closed loop to dispose a second particular one extension associating said second particular one closed loop to said second elastomeric body inside said first particular one closed loop.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1-FIG. 10 illustrates a set of representative anchor bodies, each body including one or more extensions with each extension supporting one or more semi-flexible loops, with FIG. 1-FIG. 6 illustrating representative regularly shaped anchor bodies and FIG. 7-FIG. 10 illustrating representative irregularly-shaped anchor bodies.

FIG. 1 illustrates a linear anchor body having a pair of loops, one at each end;

FIG. 2 illustrates a linear anchor body having a pair of loops at each end of the body;

FIG. 3 illustrates a rectilinear anchor body having an extension and a loop at each corner;

FIG. 4 illustrates a hexagonal anchor body having an extension and a loop at each vertex;

FIG. 5 illustrates a hexagonal anchor body having a pair of extensions at each vertex with a loop at each extension;

FIG. 6 illustrates a hexagonal anchor body having an extension at each vertex with a pair of loops at each extension;

FIG. 7 illustrates a first fanciful anchor body having a set of extensions with a loop at each extension;

FIG. 8 illustrates a second fanciful anchor body having a set of extensions with a loop at each extension;

FIG. 9 illustrates a third fanciful anchor body having a set of extensions with a loop at each extension;

FIG. 10 illustrates a fourth fanciful anchor body having a set of extensions with a loop at each extension;

FIG. 11-FIG. 12 illustrate different modes for a loop tool for use with construction;

FIG. 11 is an illustration of the loop tool with a latch in an open or unlatched mode;

FIG. 12 is an illustration of the loop tool with the latch in an closed or latched mode;

FIG. 13-FIG. 17 illustrate a sequence of construction steps for a coupling a first semi-flexible loop of a first anchor body to a second semi-flexible loop of a second anchor body;

FIG. 13 illustrates a looping of the first semi-flexible loop with the loop tool;

FIG. 14 illustrates pulling of the first semi-flexible loop down the shaft of the loop tool;

FIG. 15 illustrates a looping of the second semi-flexible loop with the loop tool;

FIG. 16 illustrates a connecting of the first semi-flexible loop to the second semi-flexible loop by pulling the first anchor body off the end of the shaft with the loop tool having the latch in the closed mode;

FIG. 17 illustrates a coupling of the coupling the first semi-flexible loop to the second semi-flexible loop;

FIG. 18 illustrates an enlarged view of the coupled bodies illustrated in FIG. 17;

FIG. 19-FIG. 24 illustrate a construction of a hybrid anchor body from other special anchor body components;

FIG. 19 illustrates a hooking of a first component anchor body with the loop tool passing through a body aperture;

FIG. 20 illustrates a pulling of the first component anchor body down the shaft of the loop tool;

FIG. 21 illustrates a looping of a first semi-flexible loop engaged with a second component anchor body;

FIG. 22 illustrates a result of the looping illustrated in FIG. 22;

FIG. 23 illustrates a connection of the first semi-flexible loop through the first component anchor body to form the hybrid anchor body;

FIG. 24 illustrates the constructed hybrid anchor body;

FIG. 25-FIG. 27 illustrate a button connector for alternative joinder of semi-flexible loops;

FIG. 25 illustrates an unjoined pair of aligned semi-flexible loops by use of a button connector, the pair of semi-flexible loops are optionally from different anchor bodies aligned to receive the button connector that will pass through both semi-flexible loops and create an alternative hybrid anchor body;

FIG. 26 illustrates a top view of the alternative hybrid anchor body;

FIG. 27 illustrates a bottom view of the alternative hybrid anchor body;

FIG. 28 illustrates a first alternative button connector;

FIG. 29 illustrates a second alternative button connector;

FIG. 30 illustrates an assembly having multiple anchor bodies joined to a single extension of another anchor body;

FIG. 31 illustrates a flexible anchor body having multiple extensions, each extension having a loop; and

FIG. 32 illustrates a folding of the flexible anchor body of FIG. 31 in which a first loop of the multiple loops is joined to a second one of its extensions.

### DETAILED DESCRIPTION OF THE INVENTION

Embodiments of the present invention provide a system and method for an amusement construction system offering simple, safe, and efficient features and solutions unavailable in any other amusement construction system. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. Thus, for example, a size of a non-spherical object can refer to a diameter of a corresponding spherical object that exhibits light scattering or other properties that are substantially the same as those of the non-spherical object. Alternatively, or in conjunction, a size of a non-spherical object can refer to an average of various orthogonal dimensions of the object. Thus, for example, a size of an object that is a spheroidal can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Each anchor body supports one or more extensions, each extension may include one or more semi-flexible loops. The loops are semi-flexible in that they may be deformed to pass through another semi-flexible loop while springingly returning to the undeformed state which is rigid enough to maintain a desired level of coupling (i.e., resist deformation to disengage the loop coupling). A decoupling strength is related to how easily the semi-flexible loops deform sufficiently to pass through a loop to which it is coupled.

In some implementations, the anchor body and its extension(s) and their semi-flexible loop(s) may all be integrated together and manufactured in a monolithic format from the same elastomeric material. In other implementations, it may be that only the loops are semi-flexible, or only the extensions and loops are semi-flexible. The particular elastomeric polymer selected for the various structures may be selected to tune a performance according to its design goals. These goals may include how difficult it is to couple and decouple the semi-flexible loops. As the semi-flexible loops are more stiff and rigid, it becomes more difficult to engage and couple the loops. A benefit may be that, as the loops are more stiff and rigid, an assembly is more resistant to premature deconstruction or untimely failure of a connection.

However, as the semi-flexible loops are less stiff and rigid, it becomes less difficult to engage and couple the loops. A drawback may be that, as the loops are less stiff and rigid, an assembly is less resistant to premature deconstruction or untimely failure of a connection.

A stiffness of the material for the semi-flexible loops may also affect how quickly the semi-flexible loop returns to its undistorted form after a distortion caused by engaging or disengaging semi-flexible loops. As illustrated, the semi-flexible loops return to within 85% of their undistorted form almost immediately, within 1 second or less.

It would not be possible to illustrate all the permutations for regularly and irregularly shaped anchor bodies with varying numbers of extensions and semi-flexible loops. The following illustrates and examples provide guidance on the variety of possible anchor bodies that may be employed, which is limitless in the number of permutations.

What is constant is that an anchor body includes at least one extension that includes at least one semi-flexible loop. Each extension includes a width and a height and each semi-flexible loop that is to be associated with that extension includes an inner aperture that is complementary to the width and height (i.e., the aperture will accept the dimensions of the associated extension).

In the following illustrations and description, the term “loop” is not to be necessarily limited to circularly or arcuate shapes as many different loop perimeter shapes may be implemented. For example, arrow, triangular, square, rectangular, oval, or other shaped loops may sometimes be preferred for utility or aesthetic reasons.

The apertures of the loops also need not be limited to circular disk shaped voids. Some implementations may have other profiles, such as arrow, triangular, square, rectangular, oval, or other shaped apertures may sometimes be preferred for utility or aesthetic reasons.

In some of the descriptions, a semi-flexible loop from an extension from one anchor body is illustrated as engaging with a semi-flexible loop from an extension of a different anchor body. For those implementations having one or both of the anchor body or extension also flexible, it may be possible to join semi-flexible loops of the same anchor body together.

Some of the anchor bodies include a foundation having a regular polygonal perimeter. These foundations may include a central regularly or irregularly shaped polygonal aperture. For these polygons, the perimeter and optional aperture or void, they have N number of sides, with N being an integer selected from the set {3, 4, 5, 6, 7, 8, 9, 10, 11, 12, or more}, with N for the perimeter not necessarily matching the N for the optional aperture.

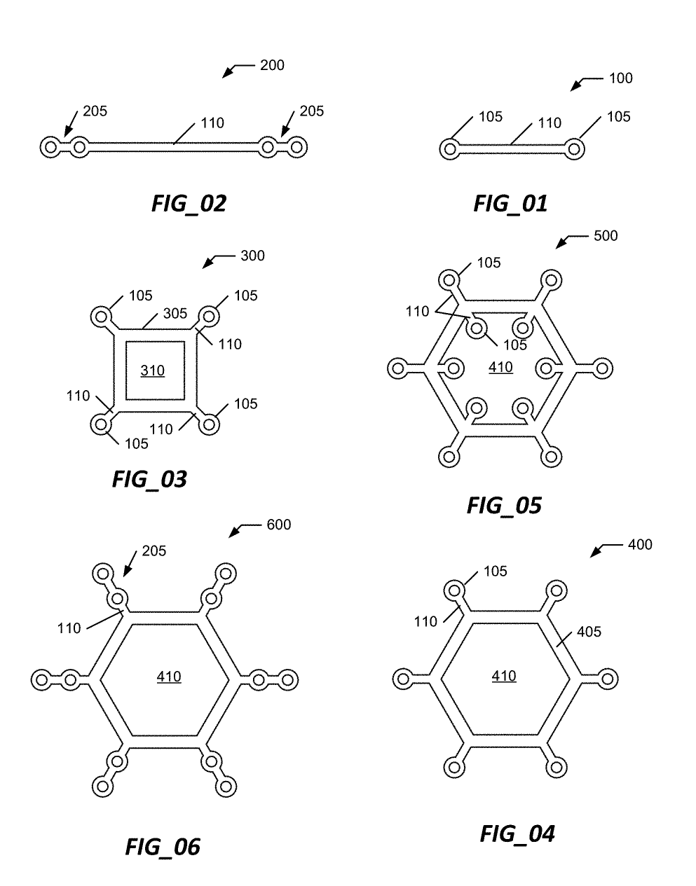

FIG. 1-FIG. 10 illustrates a set of representative anchor bodies, each body including one or more extensions with each extension supporting one or more semi-flexible loops, with FIG. 1-FIG. 6 illustrating representative regularly-shaped anchor bodies and FIG. 7-FIG. 10 illustrating representative irregularly-shaped anchor bodies.

FIG. 1 illustrates a linear anchor body 100 having a pair of loops 105, one at each end of an extension 110 that passes between loops 105.

FIG. 2 illustrates a linear anchor body 200 having a pair of loops 205 at each end of an extension 110 that passes between pairs of loops 205.

FIG. 3 illustrates a rectilinear anchor body 300 including a square foundation 305 having extension 110 and loop 105 at each vertex. As noted above, foundation 305 may include an optional central polygonal void 310, here shaped as a complementary square shape.

FIG. 4 illustrates a hexagonal anchor body 400 including a regular hexagonal foundation 405 having extension 110 and loop 105 at each vertex. As noted above, foundation 405 may include an optional central polygonal void 410, here shaped as a complementary hexagonal shape.

FIG. 5 illustrates a hexagonal anchor body 500 similar to anchor body 400 except having a pair of extensions 105 at each vertex with a loop 105 for each extension 105.

FIG. 6 illustrates a hexagonal anchor body 600 similar to anchor body 400 except having pair of loops 205 at each extension 110.

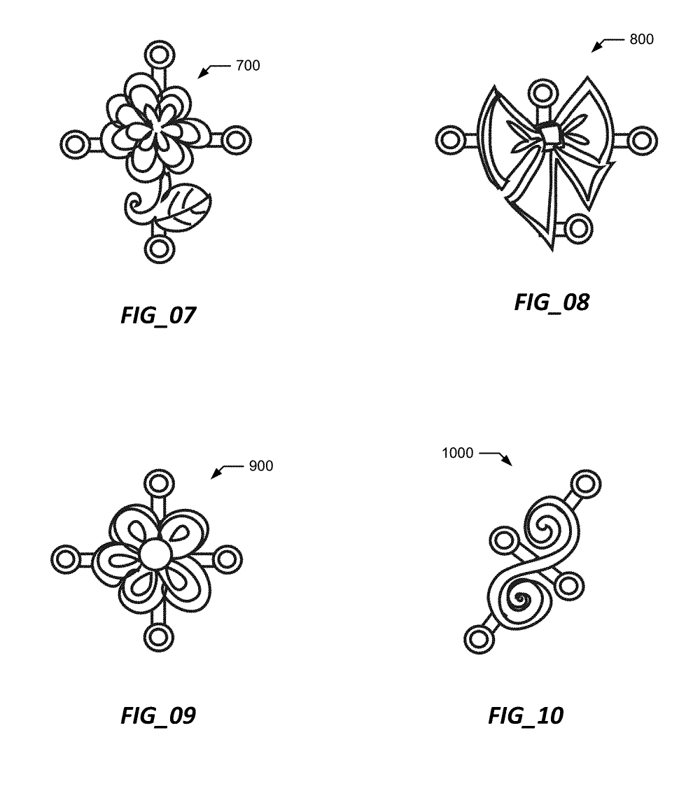

FIG. 7 illustrates a first fanciful anchor body 700, FIG. 8 illustrates a second fanciful anchor body 800, FIG. 9 illustrates a third fanciful anchor body 900, and FIG. 10 illustrates a fourth fanciful anchor body 1000. Each of anchor body 700, anchor body 800, anchor body 900, anchor body 1000, have a set of extensions 110 with loop 105 at each extension. Other implementations may include a different arrangement of number and orientation of extensions and loops per extension. As illustrated, these all include M=4 number of extensions per anchor body, with the extensions angularly displaced by 360/N degrees or 90 degrees from each other. For N=3, they may be evenly separated by 120 degrees. Other implementations may have an uneven angular separation between different pairs of adjacent extensions.

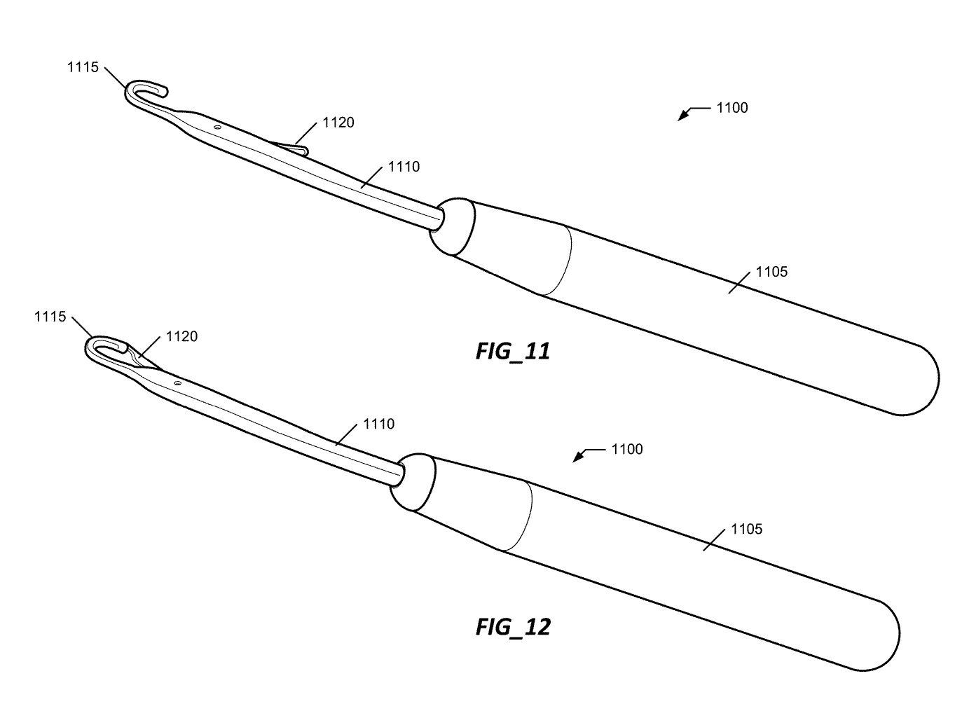

FIG. 11-FIG. 12 illustrate different modes for a loop tool 1100 for use with construction. Tool 1100 includes a handle 1105, a shaft 1110 having a proximal end coupled to handle 1105 and extending away to a hook 1115 at a distal end of shaft 1110. A moveable latch 1120 is coupled to the distal end and interoperates with hook 1115 to controllably and variably control an opening and a closing of hook 1115. FIG. 11 is an illustration of loop tool 1100 with latch 1120 in an open or unlatched mode. FIG. 12 is an illustration of loop tool 1100 with latch 1120 in an closed or latched mode.

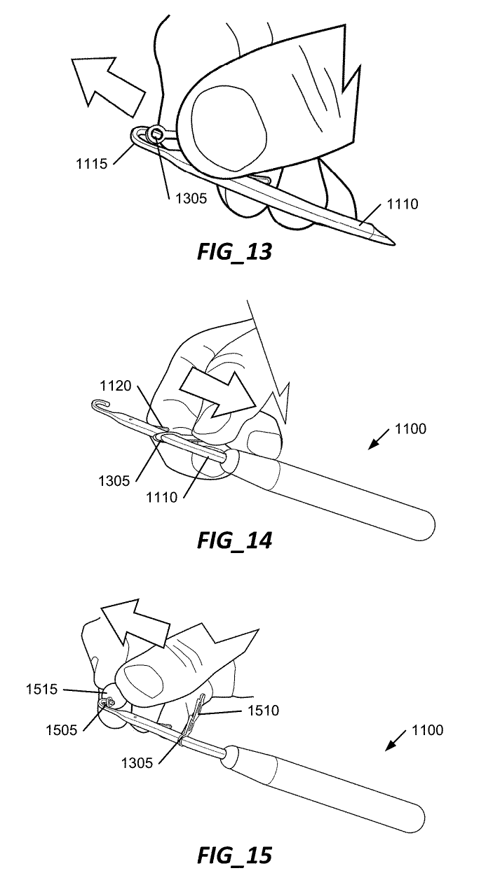

FIG. 13-FIG. 17 illustrate a sequence of construction steps for a coupling a first semi-flexible loop of a first anchor body to a second semi-flexible loop of a second anchor body. FIG. 13 illustrates a looping of a first semi-flexible loop 1305 onto hook 1115 of the loop tool illustrated in FIG. 11.

FIG. 14 illustrates a pulling of first semi-flexible loop 1305 down shaft 1110 of loop tool 1100. At this point, latch 1120 is unlatched to enable the hooked loop 1305 to slide down shaft 1110.

FIG. 15 illustrates a looping of a second semi-flexible loop 1505 onto hook 1115 of loop tool 1100. This looping requires that latch 1120 be in the unlatched position to engage hook 1115. Illustrated in FIG. 15 is a first anchor body 1510 coupled to first semi-flexible loop 1305 and a second anchor body 1515 coupled to second semi-flexible loop 1505. First anchor body 1510 may be released as it is retained to tool 1100 by the engagement of first semi-flexible loop 1305 onto shaft 1110.

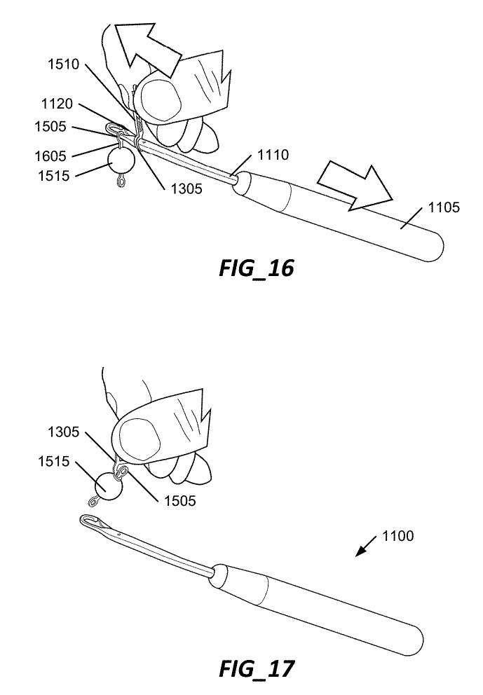

FIG. 16 illustrates a connecting of first semi-flexible loop 1305 to second semi-flexible loop 1505 by holding handle 1105 and pulling first anchor body 1510 off the end of shaft 1110 while latch 1120 is in the closed mode. Because latch 1120 is closed on second semi-flexible loop 1505, and first flexible loop 1305 is on shaft 1110, pulling first anchor body 1510 off of loop tool 1100 causes first semi-flexible loop to stretch over second semi-flexible loop 1505 and couple to a second extension 1605 of second anchor body 1515 that is coupled to second-flexible loop 1505.

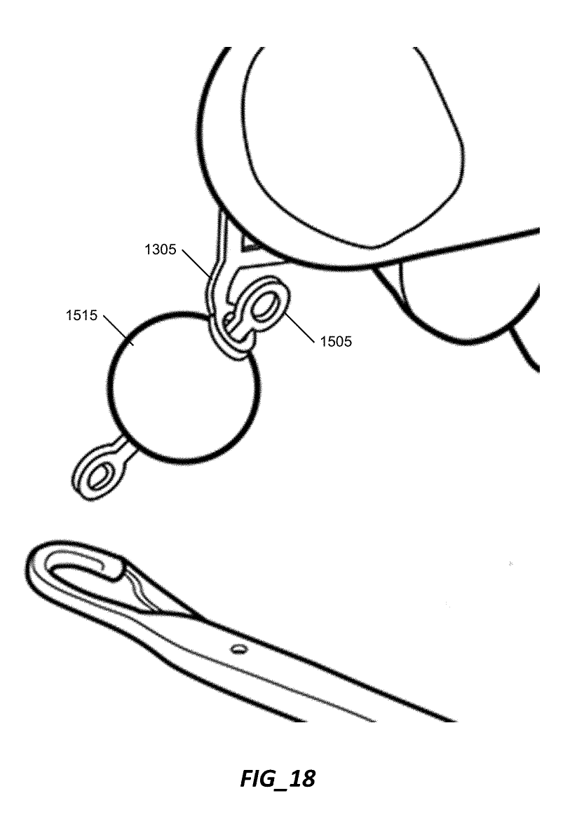

FIG. 17 illustrates a result of the process describe in FIG. 16 coupling first semi-flexible loop 1305 to second semi-flexible loop 1505. FIG. 18 illustrates an enlarged view of the result illustrated in FIG. 17.

Note that it is possible to add join multiple semi-flexible loops to a single extension, such as looping multiple anchor bodies on shaft 1110 in FIG. 14 before hooking second semi-flexible loop 1505 onto hook 1115 in FIG. 15. Or they may be added one at a time using the description herein. Also note that different order and placement will affect which loop is engaged with which extension of any particular anchor body.

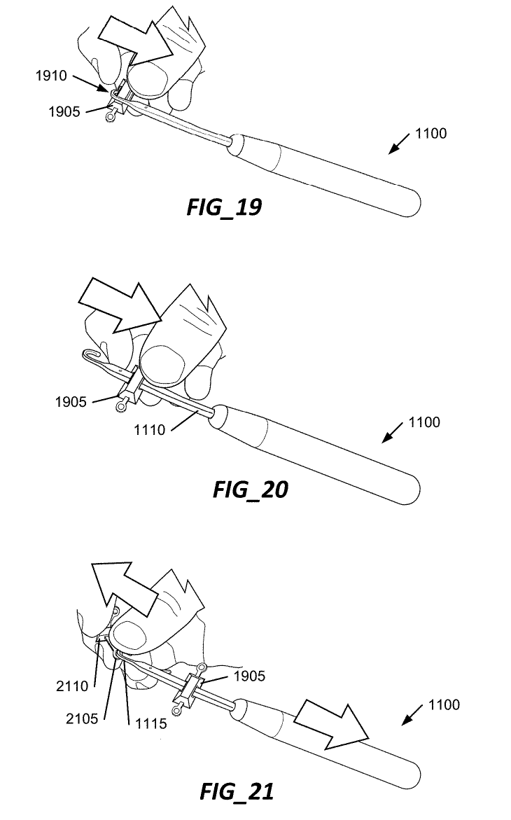

FIG. 19-FIG. 24 illustrate a construction of a hybrid anchor body from other special anchor body components (which may, in a different context, be stand-alone anchor bodies themselves). FIG. 19 illustrates a hooking of a first component anchor body 1905 with loop tool 110 passing through a body aperture 1910. FIG. 20 illustrates a pulling of first component anchor body 1905 down shaft 1110 of loop tool 1100. Shaft 1110 passes through body aperture 1910. FIG. 21 illustrates a looping of a first semi-flexible loop 2105 onto hook 1115. First semi-flexible loop 2105 is coupled to a second component anchor body 2110.

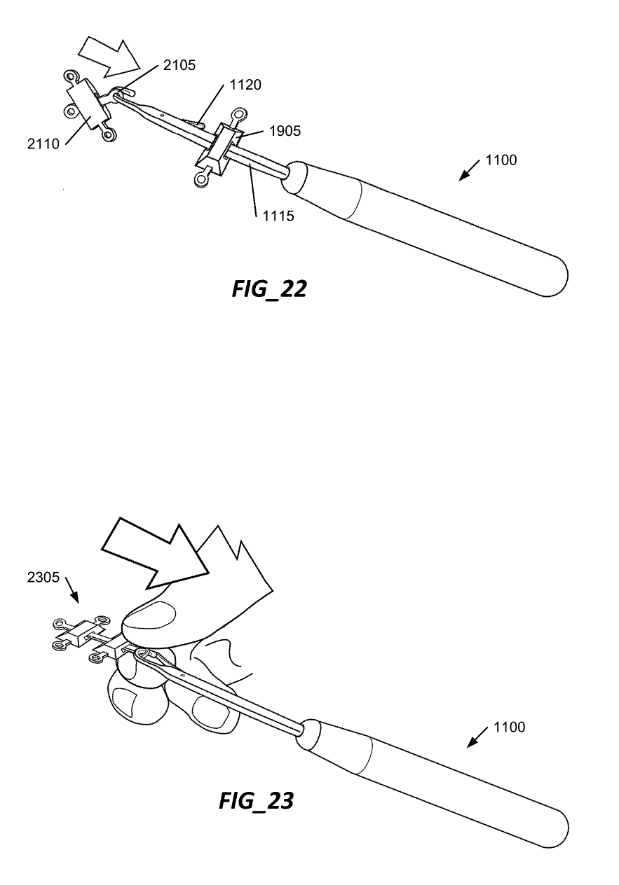

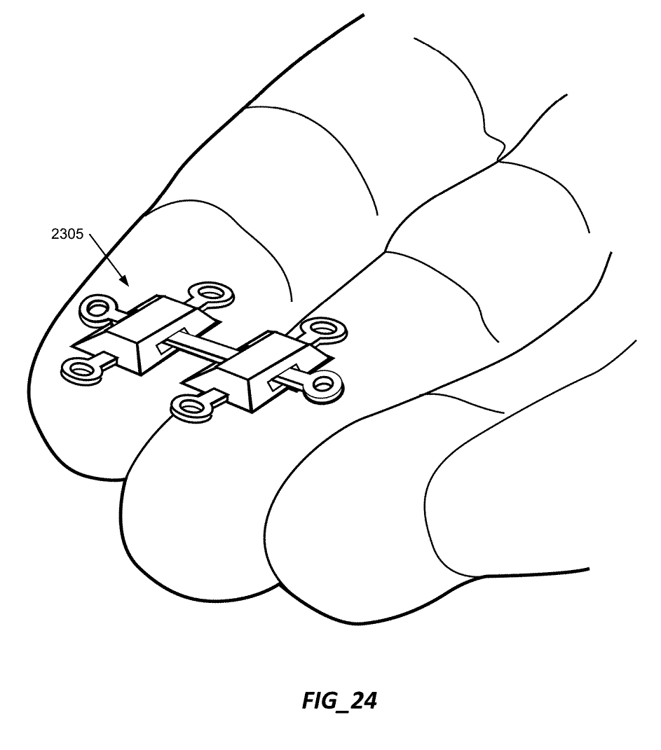

FIG. 22 illustrates a result of the looping illustrated in FIG. 22 in preparation for passing second semi-flexible loop 2105 through first component anchor body 1905. Before proceeding, latch 1120 is closed. FIG. 23 illustrates a connection of first semi-flexible loop 2105 through first component anchor body 1905 to form a hybrid anchor body 2305. FIG. 24 illustrates constructed hybrid anchor body 2305.

As illustrated, the component anchor bodies include a housing having optional integrated one or more extensions 110 and one or more semi-flexible loops 105 or pairs of semi-flexible loops 205. Also included in the illustrated component anchor bodies is a housing pass-through aperture enabling an extension from some other structure, such as for example any of the anchor bodies described herein, to be passed through. In this way, quite complex hybrid anchor bodies may be constructed as described or suggested herein.

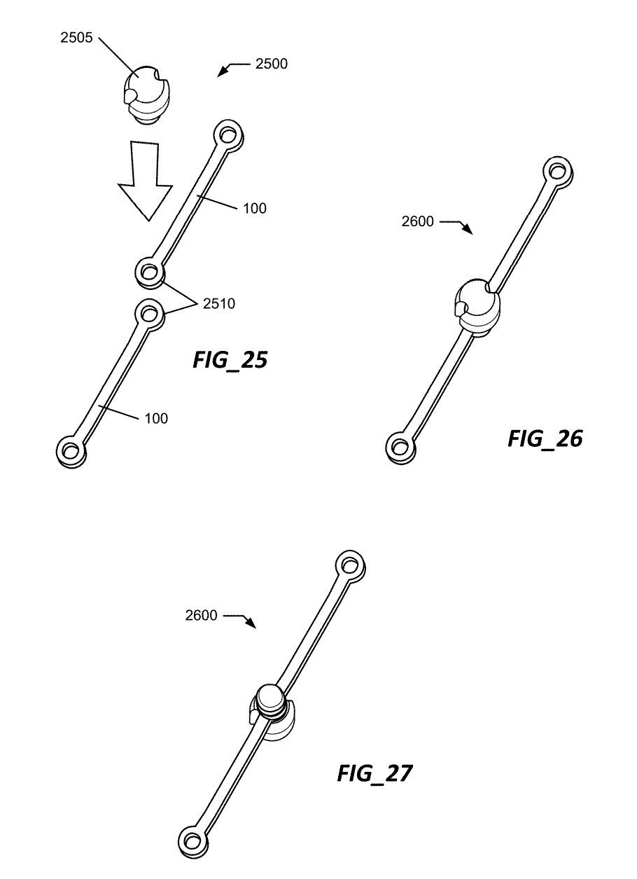

FIG. 25-FIG. 27 illustrate a coupling system 2500 including a button connector 2505 for alternative joinder of two or more aligned semi-flexible loops. FIG. 25 illustrates an unjoined pair of aligned semi-flexible loops 2510 by use of button connector 2505. To simplify this discussion, a par of anchor bodies 100 are illustrated being joined together using button connector 2505. However, any pair or more of aligned semi-flexible loops may optionally be joined using button connector 2505. FIG. 25 illustrates a pair of semi-flexible loops from different anchor bodies aligned to receive the button connector that will pass through both semi-flexible loops and create an alternative hybrid anchor body.

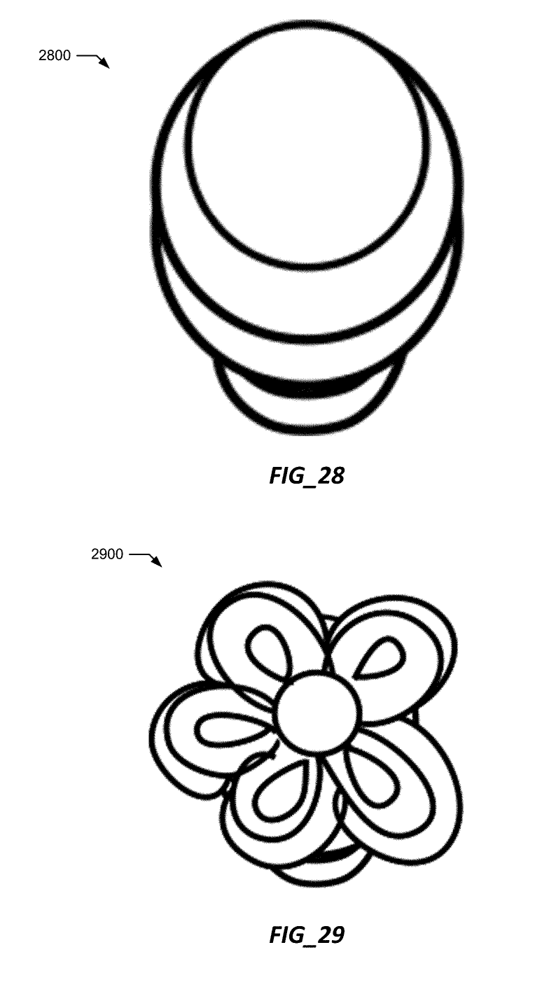

FIG. 26 illustrates a top view of an alternative hybrid anchor body 2600 produced from the process described in cooperation with FIG. 25. FIG. 27 illustrates a bottom view of alternative hybrid anchor body 2600. FIG. 28 illustrates a first alternative button connector 2800, and FIG. 29 illustrates a second alternative button connector 2900, either of which may be used in place of button connector 2505 illustrated in FIG. 25. Each button connector includes an enlarged head coupled to a body sized to pass through and secure aligned semi-flexible loops. As illustrated, the head design may vary for utility or aesthetic reasons. Button connector 2505 includes a pair of notches.

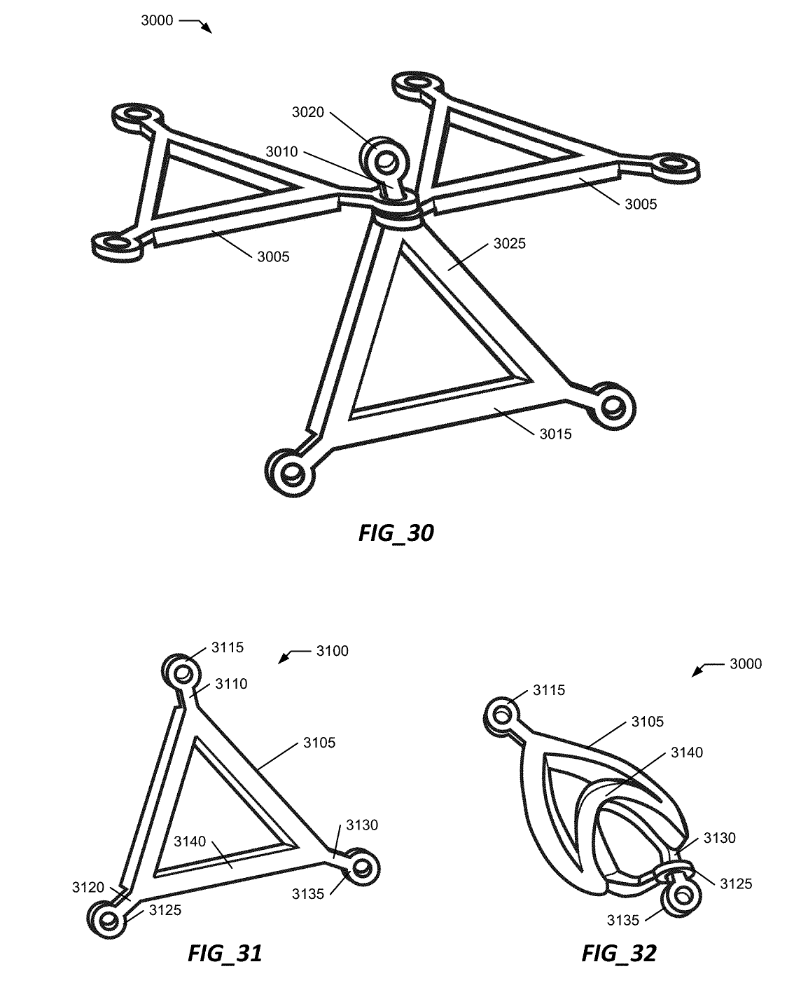

FIG. 30 illustrates an assembly 3000 having multiple anchor bodies 3005 joined to a single extension 3010 of another anchor body 3015. As illustrated, extension 3010 is sufficiently long so as to space a loop 3020 of anchor body 3015 a sufficient distance from a foundation 3025 of anchor body 3015 to allow joinder of multiple loops. Each loop has a thickness, for a monolithic implementation the foundation, extension(s), and loop(s) all have the same thickness (but it is possible to have different thicknesses for different portions). A length of an extension in general is greater than a width of an intended loop to be joined, but for extension 3010 supporting the joinder of multiple loops, extension 3010 has a minimum length of the summation of the thicknesses of the multiple loops to be supported. There may be 2, 3, 4, 5, 6, 7, 8, 9, 10, or more loops supported on, or supportable by, a single extension 3010.

FIG. 31 illustrates a flexible anchor body 3100 having a flexible foundation 3105 with multiple integrated extensions, a first extension 3110 with a first loop 3115, a second extension 3120 with a second loop 3125, and a third extension 3130 with a third loop 3135. An intermediate portion 3140 of foundation 3105 extends between vertices coupled to second extension 3120 and third extension 3130. FIG. 32 illustrates a folding of flexible anchor body 3100 in which second loop 3125 is joined to third extension 3130.

The system and methods above has been described in general terms as an aid to understanding details of preferred embodiments of the present invention. In the description herein, numerous specific details are provided, such as examples of components and/or methods, to provide a thorough understanding of embodiments of the present invention. In many of the illustrated examples, an anchor body includes multiple coplanar portions: a foundation portion with one or more vertices, one or more extension portions extending from each vertex, and one or more loop structure portions joined to each extension with each loop structure including one or more loops. Also as illustrated, the loops are closed and a loop tool may be used to “knit” one or more loops onto one or more extensions. In some cases it may be that a loop is not closed but partially open. When a gap in a loop is less than a smallest of a width or thickness of a particular extension, that partially open loop may be snapped onto the extension by opening the loop sufficiently to extend over the particular extension. A stiffness of the loop and its resistance to opening is directly related to the retaining force maintaining the coupling. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An apparatus, comprising:
an elastomeric body having a plurality of portions including a foundation portion with a first vertex and a second vertex, a first extension portion associated with said first vertex, a second extension portion associated said second vertex, a first loop structure portion coupled to said first extension portion, and a second loop structure portion coupled to said second extension portion;
wherein each said loop structure portion includes one or more closed loops, each said closed loop defining a void having a set of void metrics and having a loop thickness;
wherein each said extension portion has an extension distance from its associated vertex to its coupled loop structure portion defining an extension length that is at least equal to said loop thickness; and
wherein each said extension portion includes a cross section perimeter having a set of extension metrics compatible with said set of void metrics allowing any particular extension to extend through said void.

2. The apparatus of claim 1 wherein said body defines a plane and wherein all said portions are coplanar with said plane.

3. The apparatus of claim 1 wherein said set of void metrics define a circular void perimeter having a void diameter and wherein said set of extension metrics define a rectilinear cross section perimeter having an extension height and an extension length at least equal to said extension height.

4. The apparatus of claim 3 wherein said extension length is about equal to both said extension height and to said loop thickness.

5. The apparatus of claim 2 wherein said set of void metrics define a circular void perimeter having a void diameter and wherein said set of extension metrics define a rectilinear cross section perimeter having an extension height and an extension length at least equal to said extension height.

6. The apparatus of claim 5 wherein said extension length is about equal to both said extension height and to said loop thickness.

7. The apparatus of claim 1 wherein said foundation portion defines a closed polygonal foundation perimeter having an N number of sides with N an integer number selected from a side set having elements {3, 4, 5, 6, 7, 8, 9, 10, or more} and wherein said regular polygon includes said N number of vertices with one side extending between a pair of vertices.

8. The apparatus of claim 7 further comprising one or more additional extension portions with a total number E of extension portions at least equal to said number N (N≤E), wherein each said additional extension portion is associated with one of said vertices, and wherein each said extension portion includes one or more additional loop structure portions.

9. The apparatus of claim 2 wherein said foundation portion defines a closed polygonal foundation perimeter having an N number of sides with N an integer number selected from a side set having elements {3, 4, 5, 6, 7, 8, 9, 10, or more} and wherein said regular polygon includes said N number of vertices with one side extending between a pair of vertices.

10. The apparatus of claim 9 further comprising one or more additional extension portions with a total number E of extension portions at least equal to said number N (N≤E), wherein each said additional extension portion is associated with one of said vertices, and wherein each said extension portion includes one or more additional loop structure portions.

11. The apparatus of claim 3 wherein said foundation portion defines a closed polygonal foundation having an N number of sides with N an integer number selected from a side set having elements {3, 4, 5, 6, 7, 8, 9, 10, or more} and wherein said regular polygon includes said N number of vertices with one side extending between a pair of vertices.

12. The apparatus of claim 11 further comprising one or more additional extension portions with a total number E of extension portions at least equal to said number N (N≤E), wherein each said additional extension portion is associated with one of said vertices, and wherein each said extension portion includes one or more additional loop structure portions.

13. The apparatus of claim 5 wherein said foundation portion defines a closed polygonal foundation having an N number of sides with N an integer number selected from a side set having elements {3, 4, 5, 6, 7, 8, 9, 10, or more} and wherein said regular polygon includes said N number of vertices with one side extending between a pair of vertices.

14. The apparatus of claim 13 further comprising one or more additional extension portions with a total number E of extension portions at least equal to said number N (N≤E), wherein each said additional extension portion is associated with one of said vertices, and wherein each said extension portion includes one or more additional loop structure portions.

15. The apparatus of claim 14 wherein said closed polygonal foundation portion defines a foundation regular polygon having said N number of sides.

16. The apparatus of claim 15 wherein said foundation regular polygon further defines a foundation aperture portion.

17. The apparatus of claim 16 wherein said foundation aperture portion further defines a void portion regular polygon having said N number of sides.

18. A construction set, comprising:
one or more first elastomeric bodies each having a first plurality of portions including a first foundation portion defining a first set of vertices, a first set of extension portions associated with said first set of vertices with a least one extension portion at each said vertex of said first set of vertices, and a first set of loop structure portions associated with said first set of extensions with at least one loop structure portion at each said extension portion of said first set of extension portions;
one or more second elastomeric bodies each having a second plurality of portions including a second foundation portion defining a second set of vertices, a second set of extension portions associated with said second set of vertices with a least one extension portion at each said vertex of said second set of vertices, and a second set of loop structure portions associated with said second set of extensions with at least one loop structure portion at each said extension portion of said second set of extension portions;
wherein each said loop structure portion includes one or more closed loops, each said closed loop defining a void having a set of void metrics and having a loop thickness;
wherein each said extension portion has an extension distance from its associated vertex to its coupled loop structure portion defining an extension length that is at least equal to said loop thickness; and
wherein each said extension portion includes a cross section perimeter having a set of extension metrics compatible with said set of void metrics allowing any particular extension to extend through said void.

19. The construction set of claim 18 wherein said body defines a plane and wherein all said portions are coplanar with said plane.

20. The construction set of claim 18 wherein said set of void metrics define a circular void perimeter having a void diameter and wherein said set of extension metrics define a rectilinear cross section perimeter having an extension height and an extension length at least equal to said extension height.

21. The construction set of claim 20 wherein said extension length is about equal to both said extension height and to said loop thickness.

22. A construction method, comprising:
a) hooking, using a hook portion of a hook latch tool in an unlatched mode, a first particular one closed loop of a first elastomeric body having a plurality of portions including a foundation portion with a first vertex and a second vertex, a first extension portion associated with said first vertex, a second extension portion associated said second vertex, a first loop structure portion coupled to said first extension portion, and a second loop structure portion coupled to said second extension portion; wherein each said loop structure portion includes one or more closed loops, each said closed loop defining a void having a set of void metrics and having a loop thickness; wherein each said extension portion has an extension distance from its associated vertex to its coupled loop structure portion defining an extension length that is at least equal to said loop thickness; and wherein each said extension portion includes a cross section perimeter having a set of extension metrics compatible with said set of void metrics allowing any particular extension to extend through said void;
b) transitioning, beyond a latching portion of said hook latch tool, said first particular one closed loop down a shaft portion of said hook latch tool with said shaft portion coupled to said hook portion;
c) hooking, using said hook portion, a second particular one closed loop from said first elastomeric body or a second elastomeric body conforming to said first elastomeric body;
d) transitioning said hook latch tool to a closed mode while said second particular one closed loop is hooked by said hook portion;
e) transitioning said first particular one closed loop off said shaft portion and beyond said hook portion off of said hook latch tool which also transitions said first particular one closed loop over said second particular one closed loop to dispose a second particular one extension associating said second particular one closed loop to said second elastomeric body inside said first particular one closed loop.
